(19) United States
(12) Patent Application Publication
(10) Pub. No.: US 2024/0235285 A1
(43) Pub. Date: Jul. 11, 2024

(54) MOTOR, FAN, AND AIR CONDITIONER

(71) Applicant: Mitsubishi Electric Corporation, Tokyo (JP)

(72) Inventor: Yuji HIROSAWA, Tokyo (JP)

(21) Appl. No.: 18/559,462

(22) PCT Filed: Jun. 10, 2021
(86) PCT No.: PCT/JP2021/022078

§ 371 Date: Nov. 7, 2023

(51) Int. Cl. H02K 1/14; H02K 1/16; H02K 3/34; H02K 3/48; H02K 7/14

(52) U.S. Cl. CPC H02K 1/148; H02K 1/16; H02K 3/345; H02K 3/48; H02K 7/14; H02K 2203/03

(57) ABSTRACT

A motor includes a rotor and a stator. The rotor has a rotor core having an annular shape about an axis, and a permanent magnet attached to the rotor core. The permanent magnet forms a magnet magnetic pole, and a part of the rotor core forms a virtual magnetic pole. The stator has a stator core surrounding the rotor core in a radial direction about the axis, and a coil wound on the stator core. The stator core has a slot in which the coil is housed. The stator core has a first core part located at a center of the stator core in an axial direction, and a second core part located at an end of the stator core in the axial direction. An area of the slot in the second core part is larger than an area of the slot in the first core part.

### CROSS-REFERENCE TO RELATED APPLICATION

This application is a U.S. National Stage Application of International Application No. PCT/JP2021/022078 filed on Jun. 10, 2021, the contents of which are incorporated herein by reference.

### TECHNICAL FIELD

The present disclosure relates to a motor, a fan, and an air conditioner.

### BACKGROUND

Motors including consequent pole rotors have been developed in recent years. In such a consequent pole rotor, a magnet magnetic pole is formed by a permanent magnet attached to a rotor core, and a virtual magnetic pole is formed by a part of the rotor core (see, for example, Patent Reference 1).

### PATENT REFERENCE

Patent Reference 1: International Publication No. WO2018/037449 (see FIG. 9)

Magnetic flux from a rotor is interlinked with a coil of a stator of a motor, and thereby a driving force is generated. Since the virtual magnetic pole of the rotor includes no permanent magnet, the distribution of magnetic flux density in the virtual magnetic pole tends to be deviated under the influence of a stator magnetic field. Such a deviation in the distribution of the magnetic flux density causes an increase in an iron loss of the stator core, and the temperature of the stator core tends to increase.

### SUMMARY

The present disclosure is made to solve the above described problem, and an object of the present disclosure is to suppress a temperature rise of a stator core in a motor using a consequent pole rotor.

A motor of the present disclosure includes a rotor and a stator. The rotor has a rotor core having an annular shape about an axis, and a permanent magnet attached to the rotor core. The permanent magnet forms a magnet magnetic pole, a part of the rotor core forms a virtual magnetic pole. The stator has a stator core surrounding the rotor core from outside in a radial direction about the axis, and a coil wound on the stator core, and an insulating portion located between the stator core and the coil. The stator core has a slot in which the coil is housed, and a tooth adjacent to the slot in a circumferential direction about the axis. The stator core has a first core part located at a center of the stator core in a direction of the axis, and a second core part located at an end of the stator core in the direction of the axis. A width of the tooth in the circumferential direction in the first core part is larger than a width of the tooth in the circumferential direction in the second core part. An area of the slot in the second core part is larger than an area of the slot in the first core part. The insulating portion is engaged with a step portion located at a portion of the tooth where the width of the tooth changes. The coil is wound on the tooth of the stator core by regular winding.

According to the present disclosure, since the area of the slot in the second core part of the stator core is larger than the area of the slot in the first core part, the coil can be wound so as to minimize the distance between the coil and the stator core. Consequently, heat of the stator core can be dissipated through the coil, and a temperature rise of the stator core can be suppressed.

### BRIEF DESCRIPTION OF THE DRAWINGS

FIG. 1 is a longitudinal sectional view illustrating a motor in a first embodiment.

FIG. 2 is a cross sectional view illustrating the motor in the first embodiment.

FIG. 3 is a cross sectional view illustrating a rotor core and permanent magnets in the first embodiment.

FIG. 4 is a plan view illustrating a first core part of a stator core in the first embodiment.

FIG. 5 is a plan view illustrating a second core part of the stator core in the first embodiment.

FIG. 6(A) is a perspective view illustrating the stator core in the first embodiment, FIG. 6(B) is a perspective view illustrating the stator core and insulators, and FIG. 6(C) is a perspective view illustrating the stator core, the insulators, and an insulating film.

FIG. 7(A) is a sectional view illustrating a tooth and an insulating portion in the first embodiment, and FIG. 7(B) is a sectional view illustrating a tooth and an insulating portion of a comparative example.

FIG. 8(A) is a schematic view illustrating a state where a coil is wound around the tooth in the first embodiment, and FIG. 8(B) is a schematic view illustrating a state where a coil is wound around the tooth of the comparative example.

FIG. 9 is a schematic view illustrating a method for winding the coil around the tooth in the first embodiment.

FIG. 10 is a sectional view illustrating a state where the coil is wound around the tooth in the first embodiment.

FIG. 11 is a side view illustrating a state where the coil is wound around the tooth in the first embodiment.

FIGS. 12(A) and 12(B) are views illustrating arrangement of coil wires in layers of the coil in the first embodiment.

FIG. 13 is a cross sectional view illustrating a rotor of the comparative example.

FIG. 14 is a cross sectional view illustrating a stator core in a second embodiment.

FIGS. 15(A) and 15(B) are views illustrating a state where the stator core in the second embodiment is linearly expanded.

FIG. 16(A) is a view illustrating an air conditioner to which the motors of the embodiments are applicable, and FIG. 16(B) is a sectional view illustrating an outdoor unit of the air conditioner.

### DETAILED DESCRIPTION

### First Embodiment

### (Configuration of Motor 2)

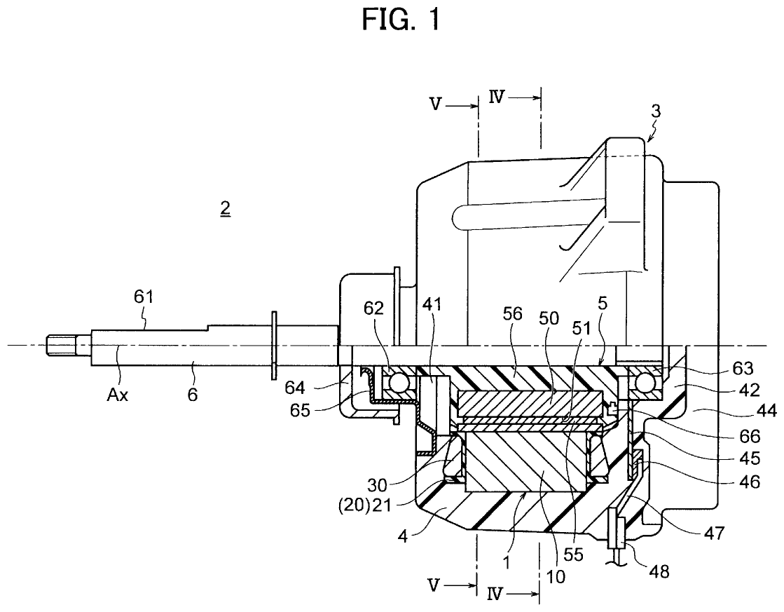

FIG. 1 is a longitudinal sectional view illustrating a motor 2 in a first embodiment. The motor 2 is used in, for example, a fan of an air conditioner and driven by an inverter. The motor 2 is an Interior Permanent Magnet (IPM) motor in which permanent magnets 55 are embedded in a rotor 5.

The motor 2 includes a shaft 6, the rotor 5 attached to the shaft 6, and a mold stator 3 surrounding the rotor 5. The mold stator 3 includes an annular stator 1 surrounding the rotor 5, and a molding resin portion 4 covering the stator 1. The shaft 6 is a rotating shaft of the rotor 5.

In the following description, a direction of an axis Ax that is a center axis of the shaft 6 will be referred to as an “axial direction.” A circumferential direction about the axis Ax will be referred to as a “circumferential direction,” and a radial direction about the axis Ax will be referred to as a “radial direction.” A sectional view in a plane orthogonal to the axis Ax will be referred to as a “cross sectional view,” and a sectional view in a plane parallel to the axis Ax will be referred to as a “longitudinal sectional view.”

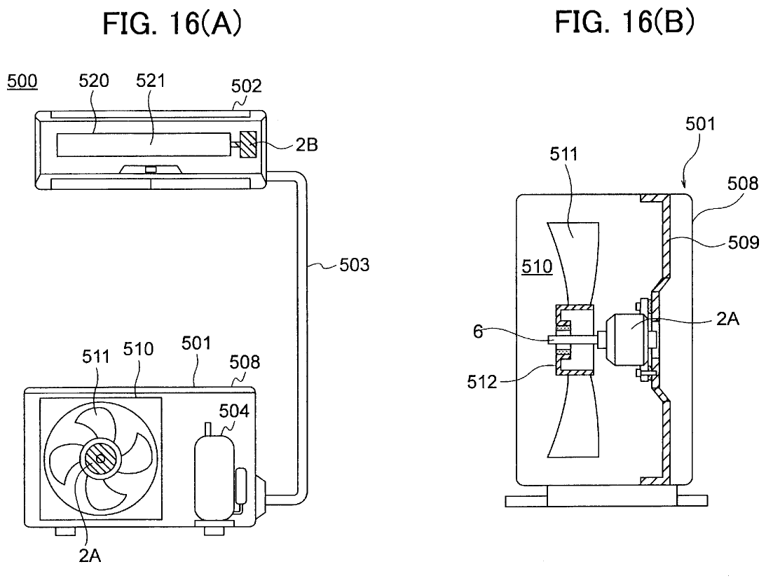

The shaft 6 projects leftward in FIG. 1 from the mold stator 3, and an impeller 511 (FIG. 16(A)) of a fan, for example, is attached to an attachment portion 61 formed on the projecting portion. Thus, a projection side (left in FIG. 1) of the shaft 6 will be referred to as a “load side,” and the opposite side (right in FIG. 1) will be referred to as a “counter-load side.”

### (Configuration of Mold Stator 3)

As described above, the mold stator 3 includes the stator 1 and the molding resin portion 4. The molding resin portion 4 is formed of a thermosetting resin such as an unsaturated polyester resin or an epoxy resin. The unsaturated polyester resin is, for example, a bulk molding compound (BMC).

The molding resin portion 4 covers an outer side of the stator 1 in the radial direction and a counter-load side of the stator 1. The molding resin portion 4 includes an opening 41 at a load side and a bearing support portion 42 at a counter-load side. The rotor 5 is inserted in the stator 1 through the opening 41.

A metal bracket 65 is attached to the opening 41 of the molding resin portion 4. A first bearing 62 supporting the shaft 6 is held by the bracket 65. A waterproof cap 64 is attached to the shaft 6 to cover the outer side of the bracket 65. A second bearing 63 supporting the shaft 6 is held by the bearing support portion 42 of the molding resin portion 4.

A circuit board 45 is disposed at the counter-load side of the stator 1. The circuit board 45 is covered with the molding resin portion 4. A driving circuit 46, a magnetic sensor, and other devices necessary for driving the motor 2 are mounted on the circuit board 45.

Lead wires 47 electrically connected to a coil 30 of the stator 1 are wired on the circuit board 45. The lead wires 47 are drawn to the outside through a lead wire outlet part 48 disposed on an outer peripheral portion of the molding resin portion 4.

A heat dissipator 44 is preferably disposed at a side opposite to the stator 1 with respect to the circuit board 45. The heat dissipator 44 is made of, for example, a metal such as aluminium. A portion of the heat dissipator 44 on the side opposite to the stator 1 is exposed from the molding resin portion 4, and the other portion of the heat dissipator 44 is covered with the molding resin portion 4.

The heat dissipator 44 may be a heat sink having ribs at a portion exposed from the molding resin portion 4, or may be a plate-shaped heat dissipating plate. The heat dissipator 44 has a function of dissipating heat generated in the stator 1 and the circuit board 45 to the outside.

The motor 2 is not limited to a motor including the molding resin portion 4. For example, the stator 1 of the motor 2 may be fixed to an inner side of a cylindrical shell mainly containing iron (Fe) by shrink fitting or the like.

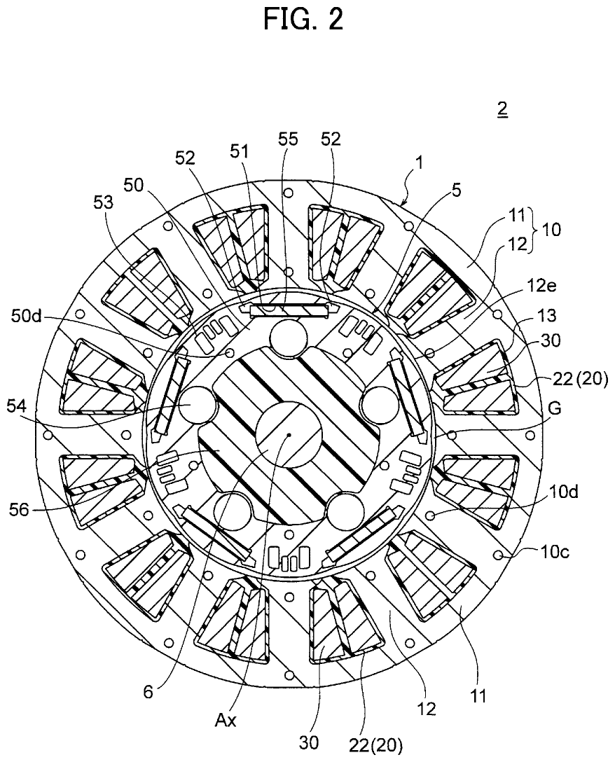

FIG. 2 is a cross sectional view illustrating the stator 1 and the rotor 5 of the motor 2. FIG. 2 does not show the molding resin portion 4. The stator 1 includes a stator core 10 surrounding a rotor core 50 from outside in the radial direction via an air gap G, an insulating portion 20 provided on the stator core 10, and the coil 30 wound on the stator core 10 via the insulating portion 20.

The stator core 10 is obtained by stacking a plurality of stacking elements in the axial direction and fixing the stacking elements by crimping, welding, bonding, or the like. The stacking elements are magnetic thin sheets, more specifically, steel sheets mainly containing iron. More specifically, the stacking elements are electromagnetic steel sheets. Each of the stacking elements has a thickness of 0.2 mm to 0.5 mm, for example.

The stator core 10 includes a yoke 11 extending in an annular shape about the axis Ax, and a plurality of teeth 12 extending inward in the radial direction from the yoke 11. The number of the teeth 12 is twelve in this example, but is not limited thereto. A tooth tip 12e is formed on an end of each tooth 12, and the tooth tip 12e faces the rotor 5. The width of the tooth tip 12e in the circumferential direction is wider than that of the other portion of the tooth 12.

The yoke 11 has twelve crimping portions 10c, and the teeth 12 have crimping portions 10d. The crimping portions 10c and 10d are portions at which the stacking elements of the stator core 10 are fixed to each other. The crimping portions 10c and 10d are located on a straight line in the radial direction passing through the center of each teeth 12. The number and positions of the crimping portions 10c and 10d are not limited, and the stacking elements may be fixed by a method other than crimping.

A slot 13 is formed between adjacent ones of the teeth 12 in the circumferential direction. The number of the slots 13 is equal to the number of the teeth 12. The coil 30 is wound around each of the teeth 12 via the insulating portion 20, and housed in the slots 13. The coil 30 includes a conductor made of a copper wire or an aluminium wire, and an insulating film covering the conductor.

The methods for winding the coil 30 include concentrated winding and distributed winding. Concentrated winding is employed in this example. In particular, the coil 30 is not wound around multiple ones of the teeth 12, but wound around each of the teeth 12. Such a winding method is called salient pole concentrated winding.

The insulating portion 20 includes insulators 21 (FIG. 1) disposed at end surfaces of the stator core 10 in the axial direction, and insulating films 22 disposed on the inner surfaces of the slots 13. A part of the molding resin portion 4 illustrated in FIG. 1 enters the slot 13, and covers the coil 30 together with the insulating film 22.

### (Configuration of Rotor 5)

As illustrated in FIG. 2, the rotor 5 includes the shaft 6, the rotor core 50 surrounding the shaft 6 from outside in the radial direction, and a plurality of permanent magnets 55 embedded in the rotor core 50. The number of the permanent magnets 55 is five in this example.

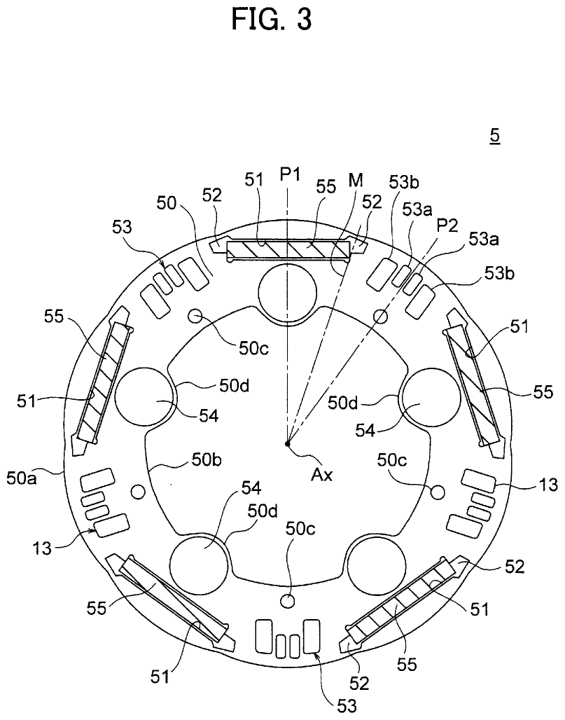

FIG. 3 is a cross sectional view illustrating the rotor core 50 and the permanent magnets 55. The rotor core 50 is a member having an annular shape about the axis Ax. The rotor core 50 has an outer circumference 50a and an inner circumference 50b, and the inner circumference 50b faces the shaft 6 (FIG. 2).

The rotor core 50 is obtained by stacking a plurality of stacking elements in the axial direction and fixing the stacking elements by crimping, welding, bonding, or the like. The stacking elements are magnetic thin sheets, more specifically, steel sheets mainly containing iron. More specifically, the stacking elements are electromagnetic steel sheets. Each of the stacking elements has a thickness of 0.2 mm to 0.5 mm, for example.

The rotor core 50 includes a plurality of magnet insertion holes 51 arranged in the circumferential direction. The magnet insertion holes 51 are arranged at equal intervals in the circumferential direction and at the same distance from the axis Ax. The number of the magnet insertion holes 51 is five in this example. The magnet insertion holes 51 are formed along the outer circumference 50a of the rotor core 50, and penetrate the rotor core 50 in the axial direction.

A permanent magnet 55 is inserted in each magnet insertion hole 51. The permanent magnet 55 has a flat plate shape, and has a rectangular cross section in a plane orthogonal to the axial direction. The permanent magnet 55 is a rare earth magnet, more specifically, a neodymium magnet containing neodymium (Nd), iron, and boron (B) or a samarium magnet containing samarium (Sm) and cobalt (Co). Instead of the rare earth magnet, a ferrite magnets may be used.

Flux barriers 52 that are openings are formed at both ends of each magnet insertion hole 51 in the circumferential direction. A thin-walled portion is formed between the flux barrier 52 and the outer circumference 50a of the rotor core 50. The thickness of the thin-walled portion is equal to, for example, the thickness of the stacking element in order to suppress short circuit of magnetic flux between adjacent ones of the permanent magnets 55.

The permanent magnets 55 are arranged so that their magnetic pole surfaces of the same polarity face the outer circumferential side of the rotor core 50. In the rotor core 50, a magnetic pole of a polarity opposite to that of the permanent magnets 55 is formed in a region between the permanent magnets 55 adjacent to each other in the circumferential direction.

Thus, in the rotor 5, magnet magnetic poles P1 constituted by the permanent magnets 55 and virtual magnetic poles P2 constituted by parts of the rotor core 50 are alternately arranged in the circumferential direction. Such a configuration is referred to as a consequent pole type. In this example, the magnet magnetic poles P1 are south poles, and the virtual magnetic poles P2 are north poles, but the polarities may be reversed. An inter-pole portion M is formed each between the magnetic poles P1 and P2 In the circumferential direction.

The rotor 5 includes five magnet magnetic poles P1 and five virtual magnetic poles P2. That is, the number of poles of the rotor 5 is ten. The ten magnetic poles P1 and P2 of the rotor 5 are arranged at equiangular intervals in the circumferential direction with a pole pitch of 36 degrees. Although the number of poles of the rotor 5 is ten in this example, it is sufficient that the number of poles is four or more. That is, it is sufficient that the number of the magnet magnetic poles P1 is two or more.

In the following description, the magnet magnetic poles P1 and the virtual magnetic poles P2 will be referred to simply as “magnetic poles” when it is not necessary to distinguish these poles. The center of each magnet magnetic pole P1 in the circumferential direction is a magnetic pole center. Similarly, the center of each virtual magnetic pole P2 in the circumferential direction is a magnetic pole center.

The outer circumference 50a of the rotor core 50 has a so-called flower shape in a cross section orthogonal to the axial direction. In other words, the outer circumference 50a of the rotor core 50 extends so that the radius of the rotor core 50 is at maximum at each magnetic pole center of the magnetic poles P1 and P2 and is at minimum at each inter-pole portion M. The outer circumference 50a of the rotor core 50 is not limited to the flower shape and may be a circular shape.

A group of slits 53 are preferably formed in the virtual magnetic pole P2. The group of slits 53 cause magnetic flux concentrated at the magnetic pole center of the virtual magnetic pole P2 to be uniformly dispersed in the circumferential direction. The group of slits 53 include, for example, two slits 53a disposed on both sides of the magnetic pole center, and two slits 53b disposed on both sides of the two slits 53a.

Each of the slits 53a and 53b is elongated in the radial direction. The opening area of the slit 53b is larger than that of the slit 53a. The number, positions, and shapes of the slits in the group of slits 53 are not limited.

The rotor core 50 has holes 54 on the inner side of the magnet insertion holes 51 in the radial direction. Each hole 54 guides the magnetic flux flowing from or into the inner magnetic pole of the permanent magnet 55 in the radial direction so that the magnetic flux flows uniformly in the circumferential direction.

Projections 50d are formed on the inner circumference 50b of the rotor core 50, and the projections 50d project in an arc shape along the hole 54. The inner circumference 50b of the rotor core 50 has a circular shape about the axis Ax except for the projections 50d. The rotor core 50 does not necessarily include the holes 54 and the projections 50d.

A crimping portion 50c is formed at the inner side of each group of slits 53 in the radial direction in the rotor core 50. The crimping portions 50c are portions at which the stacking elements of the rotor core 50 are fixed to each other. The number and positions of the crimping portions 50c are not limited, and the stacking elements may be fixed by a method other than crimping.

As illustrated in FIG. 2, a coupling portion 56 is provided between the shaft 6 and the rotor core 50. The coupling portion 56 couples the shaft 6 and the rotor core 50 to each other and is nonmagnetic.

The coupling portion 56 is made of, for example, a nonmagnetic resin such as BMC, polybutylene terephthalate (PBT), polyphenylene sulfide (PPS), or polyethylene terephthalate (PET). The coupling portion 56 may be made of a nonmagnetic metal such as austenitic stainless steel or aluminium.

The consequent pole rotor 5 has a characteristic such that the magnetic flux passing through the virtual magnetic poles P2 is likely to flow to the shaft 6. The provision of the nonmagnetic coupling portion 56 between the rotor core 50 and the shaft 6 suppresses magnetic flux leakage from the rotor core 50 to the shaft 6. The coupling portion 56 may have hollow portions or ribs.

As illustrated in FIG. 1, the coupling portion 56 also covers both end surfaces of the rotor core 50 in the axial direction. It is preferable that a part of the coupling portion 56 enters into the magnet insertion hole 51 of the rotor core 50. The entering of the part of the coupling portion 56 in the magnet insertion hole 51 suppresses displacement of the permanent magnet 55 in the magnet insertion hole 51.

A sensor magnet 66 is located at the counter-load side with respect to the rotor core 50. The sensor magnet 66 is a permanent magnet having an annular shape about the axis Ax, and held by the coupling portion 56. A magnetic field of the sensor magnet 66 is detected by a magnetic sensor of the circuit board 45, and a rotational position of the rotor 5 is detected based on the detection by the sensor magnet 66. There are cases where the rotor 5 does not include the sensor magnet 66.

The length of the rotor core 50 in the axial direction is preferably longer than the length of the stator core 10 in the axial direction. With this configuration, the magnetic flux from the rotor 5 sufficiently flows into the end surfaces of the stator core 10 in the axial direction, and thus motor efficiency is enhanced.

In this example, the coupling portion 56 is disposed between the rotor core 50 and the shaft 6. Alternatively, it is possible to fix the shaft 6 to the inner circumference 50b of the rotor core 50 without providing the coupling portion 56. The fixing method is press fitting, shrink fitting, caulking, or the like. In this case, in order to suppress the magnetic flux leakage from the rotor core 50 to the shaft 6, the shaft 6 is preferably made of a non-magnetic material such as austenitic stainless steel or aluminium.

### (Configuration for Winding Coil 30 on Stator Core 10)

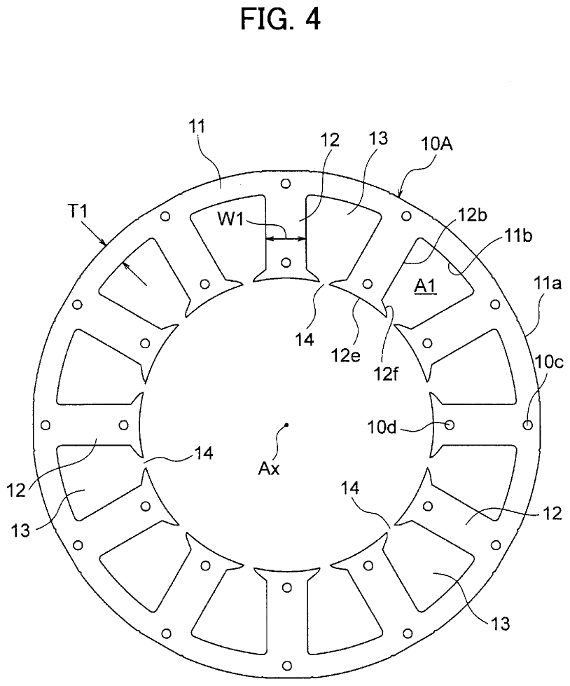

As described above with reference to FIG. 2, the stator core 10 includes the annular yoke 11 and the teeth 12 extending inward in the radial direction from the yoke 11. The slot 13 housing the coil 30 is formed between adjacent ones of the teeth 12. A slot opening 14 (FIG. 4) is formed at the inner side of each slot 13 in the radial direction, and the slot opening 14 serves as an inlet for inserting the coil 30 into the slot 13.

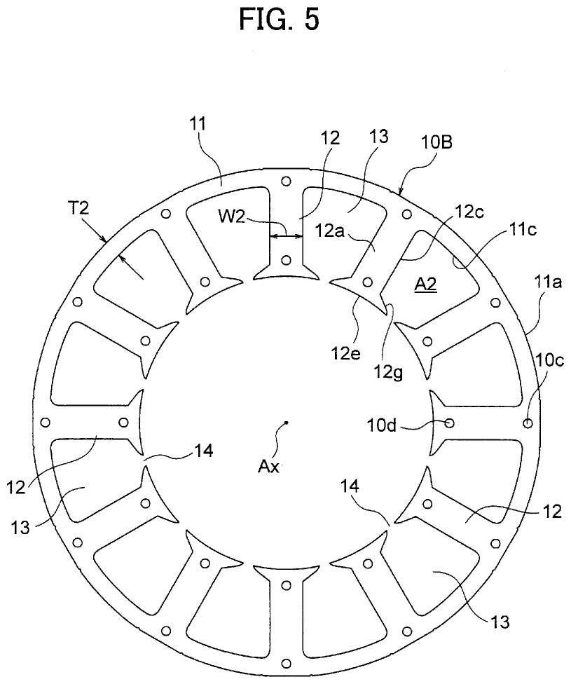

The stator core 10 also includes a first core part 10A located at a center of the stator core 10 in the axial direction (FIG. 4) and second core parts 10B located at both ends in the axial direction (FIG. 5). The area of the slot 13 is different between the first core part 10A and the second core parts 10B.

FIG. 4 is a plan view illustrating the first core part 10A of the stator core 10. Each tooth 12 of the first core part 10A has side surfaces 12b at both ends thereof in the circumferential direction. The side surfaces 12b face the slots 13. The yoke 11 of the first core part 10A has an outer circumference 11a and an inner circumference 11b. The inner circumference 11b faces the slots 13.

A width W1 of each tooth 12 of the first core part 10A in the circumferential direction is defined by a distance between two side surfaces 12b of the tooth 12 in the circumferential direction. A width T1 of the yoke 11 of the first core part 10A in the radial direction is defined by a distance between the outer circumference 11a and the inner circumference 11b of the yoke 11 in the radial direction.

FIG. 5 is a plan view illustrating the second core part 10B of the stator core 10. Each tooth 12 of the second core part 10B has side surfaces 12c at both ends thereof in the circumferential direction. The side surfaces 12c face the slots 13. The yoke 11 of the second core part 10B has an outer circumference 11a and an inner circumference 11c. The inner circumference 11c faces the slots 13.

A width W2 of each tooth 12 in the second core part 10B in the circumferential direction is defined by a distance between two side surfaces 12c of the tooth 12 in the circumferential direction. A width T2 of the yoke 11 in the second core part 10B in the radial direction is defined by a distance between the outer circumference 11a and the inner circumference 11c of the yoke 11 in the radial direction.

The width W2 of each of the teeth 12 in the second core part 10B is narrower than the width W1 of each of the teeth 12 in the first core part 10A (W1>W2). The width T2 of the yoke 11 in the second core part 10B is narrower than the width T1 of the yoke 11 in the first core part 10A (T1>T2). The outer circumference 11a of the yoke 11 is located at the same position in the radial direction between the first core part 10A and the second core part 10B.

With this configuration, an area A2 of each slot 13 in the second core part 10B is larger than an area A1 of each slot 13 in the first core part 10A (A1<A2).

Although the widths W1 and W2 of the tooth 12 satisfy W1>W2 and the widths T1 and T2 of the yoke 11 satisfy T1>T2 in this example, it is sufficient that at least the widths W1 and W2 of the tooth 12 satisfy W1>W2.

In other words, it is sufficient that the side surfaces 12c of the tooth 12 of the second core part 10B (FIG. 5) are displaced inward in the width direction of the tooth 12 relative to the side surfaces 12b of the tooth 12 of the first core part 10A (FIG. 4).

In addition, facing surfaces 12g that are surfaces of the tooth tips 12e of the second core part 10B facing the slots 13 (FIG. 5) are preferably displaced inward in the radial direction relative to facing surfaces 12f of the tooth tips 12e of the first core part 10A (FIG. 4).

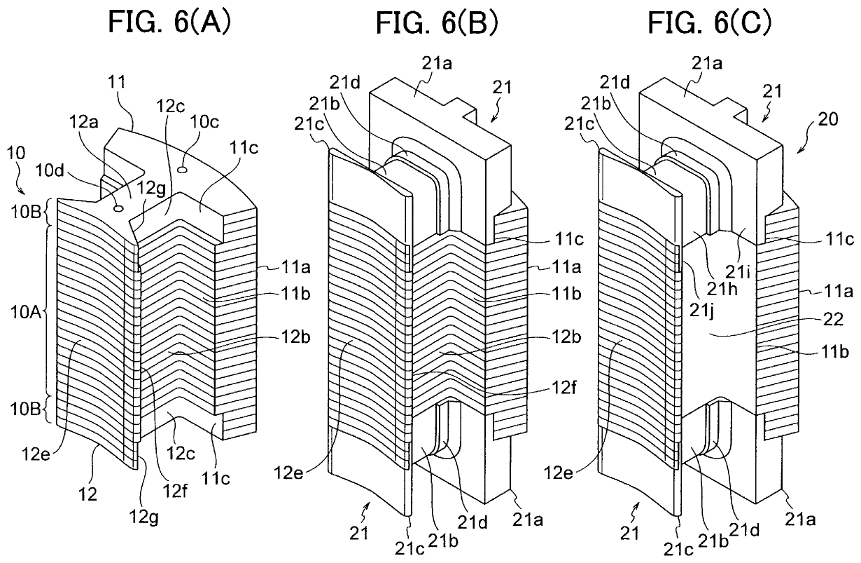

FIG. 6(A) is a perspective view illustrating a portion of the stator core 10 including one tooth 12 in a cross section passing through the yoke 11. A step portion is formed between the side surface 12b of the tooth 12 in the first core part 10A and the side surface 12c of the tooth 12 in the second core part 10B.

A step portion is also formed between the inner circumference lib of the yoke 11 in the first core part 10A and the inner circumference 11c of the yoke 11 in the second core part 10B. A step portion is also formed between the facing surface 12f of the tooth tip 12e in the first core part 10A and the facing surface 12g of the tooth tip 12e in the second core part 10B.

The insulators 21 described below are fitted to these step portions formed on the stator core 10.

FIG. 6(B) is a perspective view illustrating a state where the insulators 21 are attached to the stator core 10. The insulators 21 are attached to both ends of the stator core 10 in the axial direction, that is, the second core parts 10B (FIG. 6(A)). The insulators 21 are made of, for example, a resin such as PBT, PPS, LCP, or PET.

Each of the insulators 21 includes a wall portion 21a located on the yoke 11, a body portion 21b located on the tooth 12, and a flange portion 21c located on the tooth tip 12e of the tooth 12. The flange portion 21c and the wall portion 21a face each other in the radial direction via the body portion 21b.

The coil 30 is wound around the body portion 21b. The wall portion 21a and the flange portion 21c guide the coil 30 wound around the body portion 21b from both sides in the radial direction. The wall portion 21a and the flange portion 21c may have a step portion 21d for positioning the coil 30 wound around the body portion 21b.

FIG. 6(C) is a perspective view illustrating a state where the insulators 21 and the insulating film 22 are attached to the stator core 10. The insulating film 22 is attached to the inner surface of the slot 13 in the first core part 10A.

The insulating film 22 covers the inner circumference 11b of the yoke 11, the side surface 12b of the tooth 12, and the facing surface 12f of the tooth tip 12e (which are shown in FIG. 6(B)) in the first core part 10A. The insulating film 22 is made of, for example, a resin such as PET. The insulating film 22 has a thickness of, for example, 0.35 to 0.4 mm.

The insulators 21 and the insulating films 22 electrically insulate the stator core 10 and the coil 30 from each other. The insulators 21 and the insulating films 22 will be collectively referred to as an insulating portion 20.

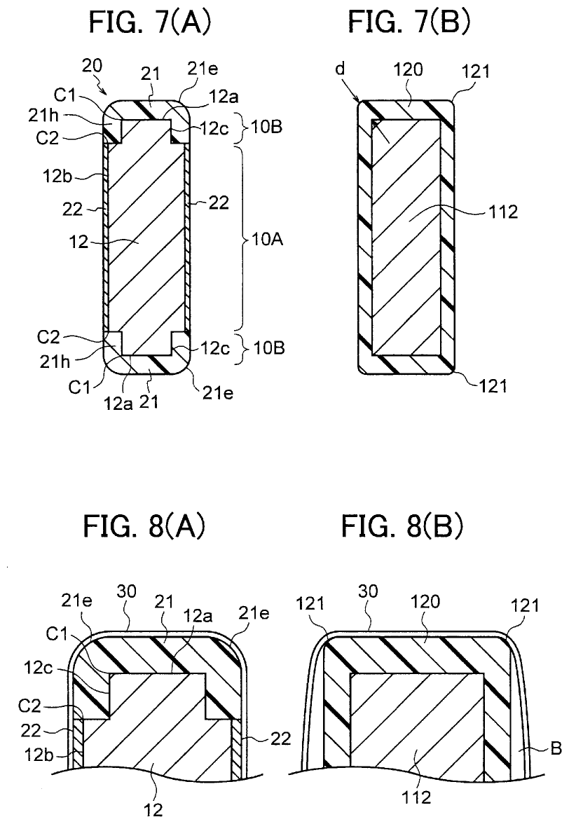

FIG. 7(A) is a sectional view of the tooth 12 and the insulating portion 20 according to the first embodiment in a plane orthogonal to the direction in which the tooth 12 extends. As illustrated in FIG. 7(A), the side surfaces 12c of the tooth 12 in the second core parts 10B are located inward in the width direction of the tooth 12 with respect to the side surfaces 12b of the tooth 12 in the first core part 10A.

Thus, step portions are formed at both sides of the tooth 12 in the second core parts 10B. The body portion 21b of each insulator 21 is attached to an end surface 12a of the tooth 12 in the axial direction so as to cover the end surface 12a, and fitted to the step portions of the tooth 12. In other words, the insulator 21 includes engagement portions 21h engaged with the step portions of the tooth 12.

In the cross section orthogonal to the direction in which the tooth 12 extends, the tooth 12 includes corners C1 each between the end surface 12a and the side surface 12c and corners C2 each between the step surface and the side surface 12b. Each insulator 21 includes corners 21e each having a curved shape and covering these corners C1 and C2. Since each corner 21e extends to cover the corners C1 and C2, a curvature radius of the corner 21e can be made large.

As is the case with the engagement portion 21h of the body portion 21b of the insulator 21, the wall portion 21a of the insulator 21 includes engagement portions 21i (FIG. 6(C)) engaged with the step portions of the yoke 11, and the flange portion 21c includes engagement portions 21j (FIG. 6(C)) engaged with the step portions of the tooth tip 12e.

FIG. 7(B) is a sectional view of a tooth 112 and an insulator 120 of a comparative example in a plane orthogonal to a direction in which the tooth 112 extends. As illustrated in FIG. 7(B), the tooth 112 of the comparative example has a rectangular cross section. The insulator 120 is attached to the tooth 112 so as to surround the tooth 112 from both sides in the circumferential direction and both sides in the axial direction.

In the comparative example, since the tooth 112 has the rectangular cross section, each corner 121 of the insulator 120 has a relatively small curvature radius. This is because if the curvature radius of each corner 121 of the insulator 120 is large, a distance d between the corner 121 of the insulator 120 and the tooth 112 is made short, and it is difficult to obtain insulation.

FIG. 8(A) is a schematic view illustrating a state where the coil 30 is wound around the tooth 12 of the first embodiment. As described with reference to FIG. 7(A), the curvature radius of each corner 21e of the insulator 21 is large, and thus the coil 30 can be wound while being in close contact with the insulators 21 and the insulating films 22. Accordingly, the distance between the tooth 12 and the coil 30 is made narrow, and heat can be transferred between the tooth 12 and the coil 30 through the insulating film 22.

FIG. 8(B) is a schematic view illustrating a state where the coil 30 is wound around the tooth 112 of the comparative example. As described with reference to FIG. 7(B), the curvature radius of each corner 121 of the insulator 120 is small, and thus a gap B is formed between the coil 30 and the insulator 120 when the coil 30 is wound on the insulator 120. This gap B hinders heat transfer between the tooth 112 and the coil 30.

As above, in the first embodiment, the width of the tooth 12 of the stator core 10 is narrower in the second core part 10B than in the first core part 10A, and accordingly, step portions are formed at both ends of the tooth 12 in the axial direction. Thus, the coil 30 can be wound while being in close contact with the insulating portion 20 surrounding the tooth 12. This enables heat of the stator core 10 to be transferred to the coil 30 through the insulating film 22.

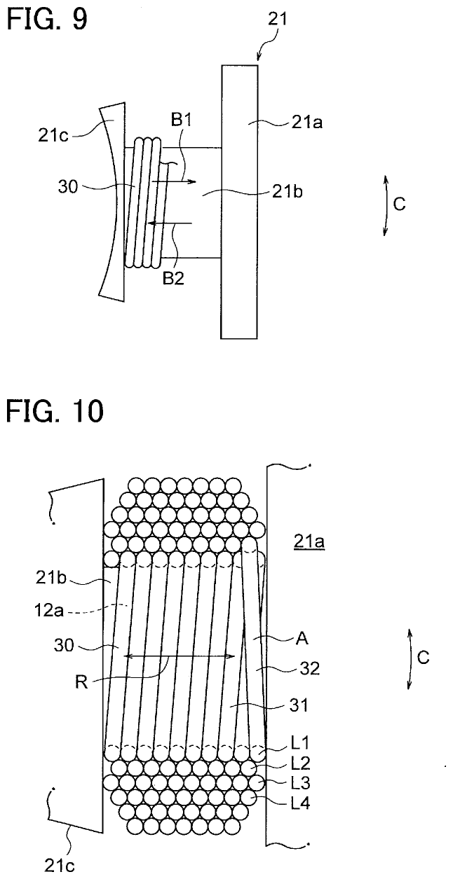

Next, a configuration for arranging the coil 30 in the slot 13 at higher density will be described. FIG. 9 is a schematic view illustrating a method for winding the coil 30 of the first embodiment. FIG. 9 is a view of the insulator 21 as seen from one side in the axial direction. In FIG. 9, the circumferential direction is indicated by arrow C. As described above, the coil 30 is wound around the body portion 21b of the insulator 21.

As indicated by arrow B1, a first layer of the coil 30 is wound from the flange portion 21c toward the wall portion 21a of the insulator 21. As indicated by arrow B2, a second layer of the coil 30 is wound from the wall portion 21a toward the flange portion 21c of the insulator 21. The directions of arrows B1 and B2 may be reversed.

FIG. 10 is a sectional view illustrating a winding pattern of the coil 30 according to the first embodiment in a plane orthogonal to the axial direction. In FIG. 10, the circumferential direction is indicated by arrow C, and the radial direction is indicated by arrow R. A first layer, a second layer, a third layer, and a fourth layer of the coil 30 are indicated by characters L1, L2, L3, and L4, respectively.

The coil wires in the layers of the coil 30 are arranged in the radial direction without clearance. That is, coil wires 31 constituting the first layer L1 extend in parallel to each other, and coil wires 32 constituting the second layer L2 also extend in parallel to each other.

On one of the end surfaces 12a of the tooth 12 in the axial direction, the coil wires 32 in the second layer L2 is inclined with respect to the coil wires 31 in the first layer L1. That is, a cross point A at which the coil wires 31 in the first layer L1 intersect with the coil wires 32 in the second layer L2 is located on the end surface 12a of the tooth 12.

Coil wires in odd-number layers (for example, third layer L3) of the coil 30 extend in parallel to the coil wires 31 in the first layer L1. Coil wires in even-number layers (for example, fourth layer L4) of the coil 30 extend in parallel to the coil wires 32 in the second layer L2. Thus, when N represents a natural number, coil wires in the N^{th} layer intersect with coil wires in the (N+1)^{th} layer on the end surface 12a of the tooth 12.

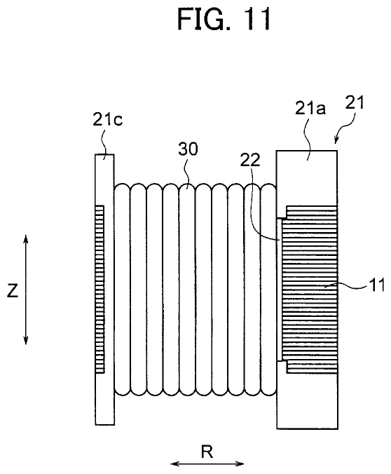

FIG. 11 is a side view of the coil 30 as seen from the slot 13 side. In the slot 13, the coil wires in each layer of the coil 30 extend in the direction (indicated by arrow Z) parallel to the axis Ax. That is, in the slot 13, all the coil wires of the coil 30 extend in parallel, and no cross point is present.

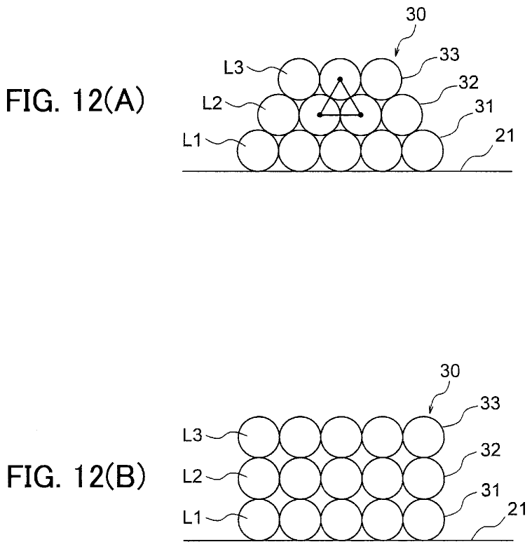

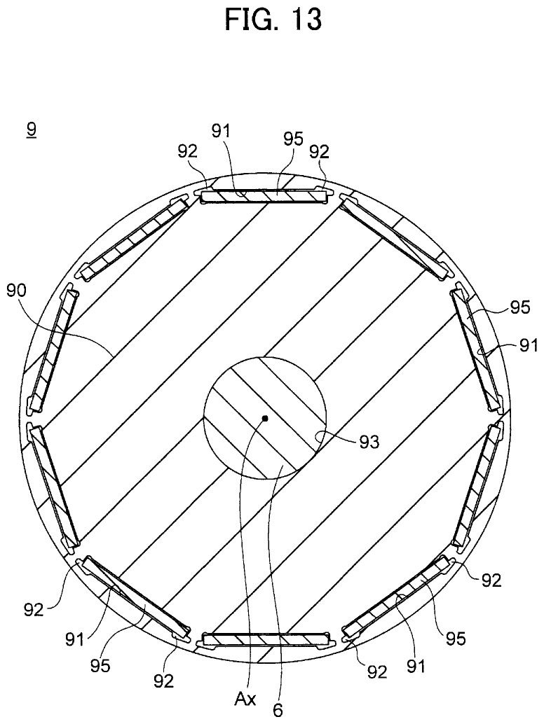

FIG. 12(A) is a schematic view illustrating a layered state of the coil 30 located in the slot 13. In the slot 13, the coil 30 is layered so that one coil wire in the (N+1)^{th} layer is in contact with two coil wires in the N^{th} layer. For example, one coil wire 33 in the third layer L3 is in contact with two coil wires 32 in the second layer L2.

In other words, the coil 30 is layered so that the center of one coil wire in the (N+1)^{th} layer and the centers of two coil wires in the N^{th} layer form an equilateral triangle. For example, the center of one coil wire 33 in the third layer L3 and the centers of two coil wires 32 in the second layer L2 form an equilateral triangle.

Such a winding method is called regular winding. In regular winding, a gap between coil wires constituting the coil 30 is narrow, and the coil 30 is arranged at a highest density. In addition, the regular winding of the coil 30 increases a space factor of the slot 13.

On the other hand, at the cross point A (FIG. 10) described above, as shown in FIG. 12(B), one coil wire in the (N+1)^{th} layer is overlaid on one coil wire in the N^{th} layer. For example, one coil wire 33 in the third layer L3 is in contact with only one of the coil wires 32 in the second layer L2. At the cross point A, a gap between coil wires constituting the coil 30 increases, and arrangement density of the coil 30 decreases.

Generally, when the coil 30 is wound so that one coil wire in the (N+1)^{th} layer of the coil 30 is in contact with two coil wires in the N^{th} layer of the coil 30 (see FIG. 12(A)) except for a portion such as the cross point A, this winding can be called regular winding.

That is, if the coil 30 is wound so that one coil wire in the (N+1)^{th} layer is in contact with two coil wires in the N^{th} layer in a larger part of the entire coil 30, this winding can be called regular winding.

The tooth 12 includes the end surfaces 12a and the side surfaces 12b as described above, and the length of each side surface 12b in the axial direction is longer than the width of each end surface 12a in the circumferential direction. Thus, the end surfaces 12a of the tooth 12 will be also referred to as short sides, and the side surfaces 12b will also be referred to as long sides.

A winding method in which the cross point A of the coil 30 is located on the end surface 12a of the tooth 12 will be referred to as short-side cross winding. On the other hand, a winding method in which the cross point A of the coil 30 is located on the side surface 12b of the tooth 12 will be referred to as long-side cross winding. The method for winding the coil 30 in the first embodiment is the short-side cross winding.

As described with reference to FIGS. 12(A) and 12(B), the arrangement density of the coil 30 decreases at the cross point A. Thus, arrangement density of the coil 30 in the slot 13 can be increased by locating the cross point A on the end surface 12a of the tooth 12.

### (Action)

The action of the embodiment will be described. First, a non-consequent pole rotor 9 of a comparative example will be described.

FIG. 13 is a cross sectional view illustrating the non-consequent pole rotor 9 of the comparative example. A rotor core 90 of the rotor 9 includes a plurality of magnet insertion holes 91 in the circumferential direction, and a permanent magnet 95 is disposed in each of the magnet insertion holes 91. A shaft hole 93 is formed at a center of the rotor core 90 in the radial direction, and a shaft 6 is fixed in the shaft hole 93.

The permanent magnets 95 adjacent to each other in the circumferential direction have magnetic pole surfaces of opposite polarities at the outer circumferential sides thereof. Thus, all the magnetic poles of the rotor 9 are formed of the permanent magnets 95. The number of the permanent magnets 95 of the rotor 9 is ten, and accordingly the number of poles of the rotor 9 is ten.

A rare earth magnet that enables obtaining high magnetic force is used for each permanent magnet 95. The rare earth magnet contains dysprosium (Dy), and is high in material cost. In addition, the permanent magnet 95 is formed by cutting a block-shaped magnet material, and is high in processing cost. Since the non-consequent pole rotor 9 includes the same number of permanent magnets 95 as the number of poles, the manufacturing cost of the non-consequent pole rotor 9 is high.

On the other hand, the rotor 5 according to the first embodiment is of the consequent pole type, and includes the magnet magnetic poles P1 and the virtual magnetic poles P2 as described with reference to FIG. 3. The number of the permanent magnets 55 can be halved as compared to the rotor 9 of the comparative example having the same number of poles, and thus the manufacturing cost of the rotor 5 can be significantly reduced.

On the other hand, the consequent pole rotor 5 has a problem such that the distribution of the magnetic flux density in the virtual magnetic poles P2 tends to be deviated. That is, in operation of the motor 2, the magnetic flux from the rotor 5 are interlinked with the coil 30 (FIG. 1) of the stator 1 to cause an induced voltage, so that a driving force for rotating the rotor 5 is generated.

In any of the magnetic poles P1 and P2 of the rotor 5, the distribution of the magnetic flux density is preferably symmetric with respect to the magnetic pole center. However, since no permanent magnet 55 is provided in the virtual magnetic pole P2, the distribution of the magnetic flux density tends to be deviated toward one side in the circumferential direction because of a magnetic field generated by a current flowing in the coil 30 of the stator 1, that is, a stator magnetic field.

When the distribution of the magnetic flux density in the virtual magnetic poles P2 is deviated, a harmonic component of the induced voltage increases, and as a result, an iron loss called a harmonic iron loss is generated in the stator core 10 where the magnetic flux of the rotor 5 flows. Since the iron loss changes to thermal energy in the stator core 10, the temperature of the stator core 10 rises.

In the first embodiment, since the width W2 of the tooth 12 in the second core part 10B of the stator core 10 (FIG. 5) is narrower than the width W1 of the tooth 12 in the first core part 10A (FIG. 4), the coil 30 can be wound while being in close contact with the insulating portion 20 surrounding the tooth 12 as described above (FIG. 8(A)).

Thus, heat generated in the stator core 10 can be dissipated through the coil 30 so that a temperature rise of the stator core 10 can be suppressed. By suppressing a temperature rise of the stator core 10, high-temperature demagnetization of the permanent magnets 55 can be suppressed, and the stable operation of the motor 2 can be achieved.

A part of heat from the stator core 10 to the coil 30 is dissipated to the outside through the circuit board 45 and the lead wires 47 (FIG. 1). Another part of heat from the stator core 10 to the coil 30 flows to the heat dissipator 44 by way of the molding resin portion 4 and is dissipated to the outside from the heat dissipator 44.

Since a current flows through the coil 30, the temperature of the coil 30 also increases due to a copper loss. When the temperature of the coil 30 increases, heat is less transferred from the stator core 10 to the coil 30.

In the first embodiment, the coil 30 is wound by regular winding and arranged at high density in the slot 13. Thus, the space factor in the slot 13 increases, and the increase in the space factor reduces the copper loss. In addition, since the coil 30 is wound while being in close contact with the insulating portion 20, the circumference length of the coil 30 decreases, and the decrease in the circumference length of the coil 30 also reduces a copper loss. Consequently, a temperature rise of the coil 30 due to the copper loss can be suppressed, and heat dissipation from the stator core 10 to the coil 30 is enabled.

Since the coil 30 is wound by regular winding, the coil 30 can be made in close contact with the insulating portion 20, and the coil wires of the coil 30 can also be made in close contact with each other. Thus, heat dissipation from the stator core 10 to the coil 30 can be promoted, and the effect of suppressing a temperature rise of the stator core 10 can be enhanced.

In the case where the coil 30 is wound around the plurality of teeth 12, a gap between the coil 30 and the insulating portion 20 is made large. However, since the coil 30 is wound in the salient pole concentrated winding, a gap is less likely to be formed between the coil 30 and the insulating portion 20. Accordingly, heat dissipation from the stator core 10 to the coil 30 can be further promoted, and the effect of suppressing a temperature rise of the stator core 10 can be further enhanced.

Since the coil 30 is wound in the short-side cross winding and the cross point A is located on the end surface 12a of the tooth 12, the coil 30 can be arranged at high density in the slot 13, so that the space factor can be increased. Accordingly, the coil 30 and the insulating portion 20 are made in closer contact with each other, and coil wires of the coil 30 can be in closer contact with each other. In addition, the increase in the space factor can reduce a copper loss of the coil 30. As a result, heat dissipation from the stator core 10 to the coil 30 can be further promoted.

Since the insulating film 22 is provided on the side of the tooth 12 facing the slot 13, the distance between the tooth 12 and the coil 30 is reduced, and heat is more likely to be transferred from the tooth 12 to the coil 30 through the insulating film 22. As a result, heat dissipation from the stator core 10 to the coil 30 can be further promoted.

Although the second core parts 10B are disposed on both ends of the stator core 10 in the axial direction in this example, it is sufficient that the second core part 10B is provided on least one end of the stator core 10 in the axial direction.

Although the magnet insertion holes 51 of the rotor core 50 are linearly formed in the direction orthogonal to a magnetic pole center line, the magnet insertion holes 51 may be formed in a V shape. Two or more permanent magnets 55 may be disposed in each magnet insertion hole 51.

The motor 2 is an IPM motor in which the permanent magnets 55 are disposed in the magnet insertion holes 51 of the rotor core 50 as described above, but may be a surface permanent magnet (SPM) motor in which the permanent magnets 55 are disposed on the surface of the rotor core 50.

### Advantages of Embodiment

As described above, the motor 2 in the first embodiment includes the consequent pole rotor 5 and the stator 1, and the stator core 10 of the stator 1 includes the first core part 10A located at the center thereof in the axial direction, and the second core part 10B located at the end thereof in the axial direction, and the area of the slot 13 is larger in the second core part 10B than in the first core parts 10A. Thus, the coil 30 can be wound in close contact with the insulating portion 20 surrounding the tooth 12, and therefore heat of the stator core 10 can be dissipated through the coil 30. Consequently, a temperature rise of the stator core 10 can be suppressed.

In particular, since the coil 30 is wound in the regular winding, the salient pole concentrated winding, and the short-side cross winding, the coil 30 and the tooth 12 are in close contact with each other via the insulating portion 20, and the coil 30 can be arranged at high density in the slot 13. As a result, heat of the stator core 10 can be efficiently dissipated through the coil 30, and the effect of suppressing a temperature rise of the stator core 10 can be enhanced.

### Second Embodiment

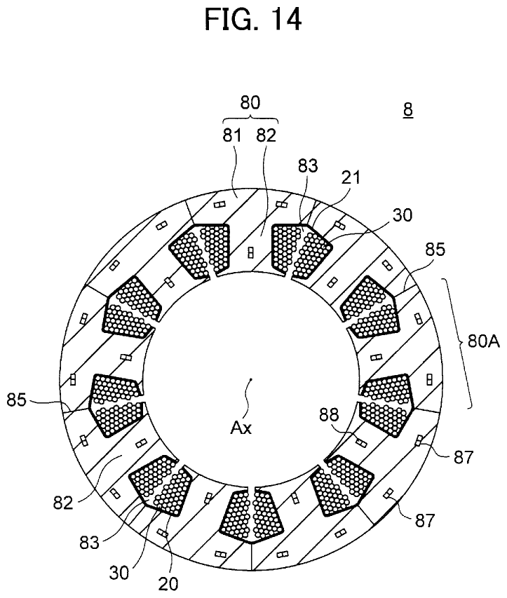

A second embodiment will now be described. FIG. 14 is a cross sectional view illustrating a stator 8 according to the second embodiment. A stator core 80 of the stator 8 includes a yoke 81 having an annular shape about an axis Ax, and a plurality of teeth 82 projecting inward in the radial direction from the yoke 81. A slot 83 housing the coil 30 is formed each between adjacent ones of the teeth 82.

The stator core 80 in the second embodiment is divided into a plurality of split cores 80A each including one tooth 82. The number of the split cores 80A is twelve in this example. The split cores 80A are divided by split surfaces 85 formed in the yoke 81. With this configuration, the stator core 80 can be linearly expanded.

Each of the split cores 80A is obtained by stacking a plurality of stacking elements and fixing the stacking elements by crimping, welding, bonding, or the like. In this example, three crimping portions 87 and 88 are formed in each of the split cores 80A. The crimping portions 87 are formed in the yoke 81, and the crimping portion 88 is formed in the tooth 82. The number and positions of the crimping portions are not limited.

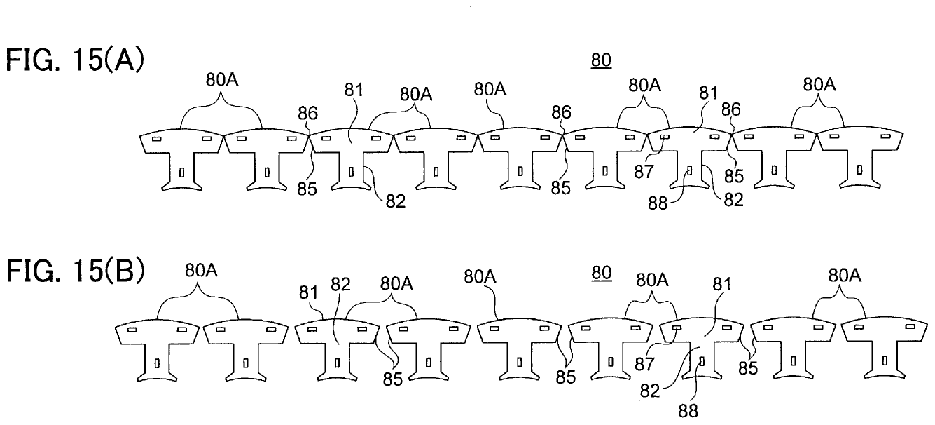

FIG. 15(A) is a view illustrating a state where the stator core 80 is linearly expanded. In the example illustrated in FIG. 15(A), adjacent ones of the split cores 80A are coupled to each other by a coupling portion 86 provided at an outer circumferential side of the split surface 85. The coupling portion 86 is a plastically deformable thin-walled portion or a crimping portion.

In forming the stator 8, the insulators 21 (FIG. 6(B)) and the insulating films 22 (FIG. 6(C)) are attached to the split cores 80A in a state where the stator core 80 is linearly expanded, and the coil 30 is wound around each tooth 82 via the insulators 21 and the insulating films 22.

Since the stator core 80 is linearly expanded, a winding nozzle for use in winding can be relatively freely moved without interference with the stator core 80, and the coil 30 can be wound at higher density.

After the coil 30 is wound around the tooth 82 of each split cores 80A, the stator core 80 is bent in an annular shape and both ends of the stator core 80 are welded, so that the stator 8 illustrated in FIG. 14 is obtained.

FIG. 15(B) is a view illustrating another example of the stator core 80. In the example illustrated in FIG. 15(B), the split cores 80A constituting the stator core 80 are not coupled to one another. These split cores 80A are integrated by welding at the split surfaces 85.

In this case, the insulators 21 (FIG. 6(B)) and the insulating films 22 (FIG. 6(C)) are attached to the split cores 80A, and the coil 30 is wound around the tooth 82 of each split core 80A via the insulators 21 and the insulating films 22. Thereafter, the split cores 80A are welded to each other at the split surfaces 85, so that the stator 8 illustrated in FIG. 14 is obtained.

Except for the aspects described above, the motor of the second embodiment is configured in a manner similar to the motor 2 of the first embodiment.

In the second embodiment, the stator core 80 is constituted by combining the plurality of split cores 80A, and thus the coil 30 can be wound at high density around the tooth 82 of each split core 80A. Accordingly, the coil 30 can be made in close contact with the insulating portion 20, and coil wires of the coil 30 can be made in close contact with each other, so that heat of the stator core 10 can be more efficiently dissipated through the coil 30. As a result, the effect of suppressing a temperature rise of the stator core 10 can be further enhanced.

### (Air Conditioner)

Next, an air conditioner to which the motors according to the embodiments described above are applicable will be described. FIG. 16(A) is a view illustrating a configuration of an air conditioner 500 to which the motor 2 according to the first embodiment is applied. The air conditioner 500 includes an outdoor unit 501 and an indoor unit 502. The outdoor unit 501 and the indoor unit 502 are connected to each other by a refrigerant pipe 503.

The outdoor unit 501 includes the outdoor fan 510 that is, for example, a propeller fan. The indoor unit 502 includes the indoor fan 520 that is, for example, a crossflow fan. The outdoor fan 510 includes an impeller 511 and a motor 2A for driving the impeller 511. The indoor fan 520 includes an impeller 521 and a motor 2B for driving the impeller 521. Each of the motors 2A and 2B is constituted by the motor 2 described in the first embodiment. FIG. 16(A) also illustrates a compressor 504 for compressing refrigerant.

FIG. 16(B) is a sectional view of the outdoor unit 501. The motor 2A is supported by a frame 509 disposed in a housing 508 of the outdoor unit 501. The impeller 511 is attached to the shaft 6 of the motor 2A via a hub 512.

In the outdoor fan 510, the impeller 511 is rotated by the motor 2A and blows air to the outside. In a cooling operation of the air conditioner 500, heat dissipated when refrigerant compressed by the compressor 504 is condensed by a condenser (not shown) is released to the outside by air blown from the outdoor fan 510.

In the indoor fan 520 (FIG. 16(A)), the impeller 521 is rotated by the motor 2B and blows air into the room. In the cooling operation of the air conditioner 500, air from which heat is taken when refrigerant evaporates in an evaporator (not shown) is blown into the room by the indoor fan 520.

Since each of the motors 2A and 2B is constituted by the motor 2 according to the first embodiment, a more stable operation can be obtained by suppression of a temperature rise of the stator core 10. Accordingly, reliability in operation of the outdoor fan 510 and the indoor fan 520 can be enhanced.

Each of the motors 2A and 2B is not limited to the motor 2 according to the first embodiment, and may be the motor according to the second embodiment. The motor of each embodiment is used for both the outdoor fan 510 and the indoor fan 520 in this example, but may be used for only one of the outdoor fan 510 and the indoor fan 520.

The motors 2 described in the embodiments are applicable not only to the fan, but also to a compressor of an air conditioner, and are also applicable to electrical equipment other than the air conditioner, such as household electrical equipment, a ventilator, or a machine tool.

Although the preferred embodiments have been specifically described, various improvements or modifications can be made to these embodiments.

1. A motor comprising:
a rotor having a rotor core having an annular shape about an axis, and a permanent magnet attached to the rotor core, the permanent magnet forming a magnet magnetic pole, a part of the rotor core forming a virtual magnetic pole; and
a stator having a stator core surrounding the rotor core from outside in a radial direction about the axis, a coil wound on the stator core, and an insulating portion located between the stator core and the coil,
wherein the stator core has a slot in which the coil is housed, and a tooth adjacent to the slot in a circumferential direction about the axis,
wherein the stator core has a first core part located at a center of the stator core in a direction of the axis, and a second core part located at an end of the stator core in the direction of the axis, and
wherein a width of the tooth in the circumferential direction in the first core part is wider than a width of the tooth in the circumferential direction in the second core part, and an area of the slot in the second core part is larger than an area of the slot in the first core part,
wherein the insulating portion is engaged with a step portion located at a portion of the tooth where the width of the tooth changes, and
wherein the coil is wound around the tooth of the stator core by regular winding.

2-4. (canceled)

5. The motor according to claim 1, wherein the coil is wound around the tooth of the stator core in salient pole concentrated winding.

6. The motor according to claim 1, wherein the coil is wound on the stator core in a plurality of layers, and
wherein coil wires in mutually different layers of the coil intersect with each other on one end surface of the tooth in the direction of the axis.

7. The motor according to claim 1, wherein the coil wires forming the coil extend in parallel with the axis in the slot.

8. The motor according to claim 1, wherein an insulating film is provided on a surface of the stator core facing the slot.

9. The motor according to claim 1, wherein the stator core is formed by combining a plurality of split cores in a circumferential direction about the axis, and each of the plurality of split cores includes one tooth.

10. The motor according to claim 1, further comprising a molding resin portion surrounding the stator.

11. The motor according to claim 10, further comprising:
a circuit board connected to the coil and covered with the molding resin portion.

12. A fan comprising:
the motor according to claim 1; and
an impeller driven to rotate by the motor.

13. An air conditioner comprising:
an outdoor unit; and
an indoor unit,
wherein at least one of the outdoor unit or the indoor unit includes the fan according to claim 12.
